(19) United States
(12) Patent Application Publication
(10) Pub. No.: US 2024/0184835 A1
(43) Pub. Date: Jun. 6, 2024

(54) RECOMMENDER SYSTEM AND ITS OPERATION

(71) Applicant: City University of Hong Kong, Kowloon (HK)

(72) Inventors: Sichun Luo, Kowloon (HK); Linqi Song, Kowloon (HK)

(21) Appl. No.: 17/861,564

(22) Filed: Jul. 11, 2022

(51) Int. Cl. G06F 16/9535; G06F 16/22

(52) U.S. Cl. CPC G06F 16/9535; G06F 16/2237

(57) ABSTRACT

A computer-implemented method for operating a recommender system. The method includes processing user-item interaction data associated with interactions between users and items and processing contextual data associated with the users and/or the items. The method further includes determining, based on the processing of the user-item interaction data and the contextual data, a recommendation of at least one of the items for at least one of the users. The user-item interaction data changes less frequently over time than the contextual data. The at least one of the users have not interacted with the at least one of the items in the recommendation.

### TECHNICAL FIELD

The invention relates to a recommender system and operation of recommender system.

### BACKGROUND

Recommender systems (or recommendation systems) are commonly used to filter information and provide recommendations to users by predicting a preference of users to items. Some existing techniques used in recommender systems include collaborative filtering and content-based filtering.

The popularity of edge devices and artificial Intelligent of Things (IoT) has driven a new wave of recommender systems for contextual recommendations, such as location-based Point of Interest (PoI) recommendations and computing-resource-aware mobile application recommendations. In these recommendation applications, contexts often drift (or change) over time. For example, in mobile game recommendation, contextual features like locations or battery power level of mobile devices may frequently drift over time. Problematically, however, existing collaborative filtering methods, in particular graph-based collaborative filtering methods are designed under the assumption that the features are static (they do not drift or drift frequently over time). As a result, these existing methods may require frequent re-training and/or would yield graphical models that rapidly increase in sizes, which make these existing methods unsuitable for these contextual recommendations.

### SUMMARY OF THE INVENTION

In a first aspect, there is provided a computer-implemented method for operating a recommender system, comprising: (a) processing user-item interaction data associated with interactions between users and items; (b) processing contextual data associated with the users and/or the items; and (c) determining, based on the processing of the user-item interaction data and the contextual data, a recommendation of at least one of the items for at least one of the users. The user-item interaction data changes less frequently over time than the contextual data. The at least one of the users have not interacted with the at least one of the items in the recommendation. In one example, the user-item interaction data is static over a period of time and the contextual data is drifting or changing over the period of time.

Optionally, step (a) comprises: (a1) processing interaction information between users and items to determine collaborative vector representations of the users and the items.

Optionally, step (b) comprises: (b1) processing contextual information of the users and the items to determine contextual vector representations associated with attributes of the users, attributes of the items, interactions between the users and the items.

Optionally, step (c) comprises: (c1) processing collaborative vector representations of one or more of the items that one of the users has interacted with, to determine user interest vector representation of an interest of the user on one of the items which the user has not interacted with; (c2) determining vector representations associated with interactions between at least two of the contextual vector representations, the collaborative vector representations, and the user interest vector representation; and (c3) processing the vector representation associated with interactions using a multilayer perceptron to determine a recommendation of at least one item for the user.

Optionally, step (c2) comprises: (c2a) determining vector representations associated with local interactions between at least two of the contextual vector representations, the collaborative vector representations, and the user interest vector representation; and (c2b) determining vector representation associated with global interactions based on the vector representations associated with local interactions, the contextual vector representations, the collaborative vector representations, and the user interest vector representation.

Optionally, in step (a1) the interaction information between users and items comprises a user-item interaction bipartite graph. The graph includes two sets, one user set with the users and one item set with the items. At least some of the users are connected with at least some of the times with edges. The edges may be associated with a weight or weighing factor.

Optionally, step (a1) comprises: processing the user-item interaction bipartite graph to determine information associated with similarities of the users and information associated with similarities of the items.

Optionally, the information associated with similarities of the users comprises a user similarity graph associated with the users, and the user similarity graph includes multiple nodes each associated with a respective one of the users.

Optionally, the information associated with similarities of the items comprises an item similarity graph associated with the items, and the item similarity graph includes multiple nodes each associated with a respective one of the items.

Optionally, the information associated with similarities of the users comprises a user similar matrix associated with the users.

Optionally, the information associated with similarities of the items comprises an item similarity matrix associated with the items.

Optionally, step (a1) further comprises: processing the item similarity graph using a graph embedding method to obtain item nodes sequence; and processing the user similarity graph using a graph embedding method to obtain user nodes sequence.

Optionally, the graph embedding method for processing the item similarity graph comprises random-walk based graph embedding method.

Optionally, the graph embedding method for processing the user similarity graph comprises random-walk based graph embedding method.

Optionally, step (a1) further comprises: processing the item nodes sequence using a co-occurrence based method to determine the collaborative vector representations of items.

Optionally, step (a1) further comprises: processing the user nodes sequence using a co-occurrence based method to determine the collaborative vector representations of users.

Optionally, in step (b1) the contextual information comprises one or some or all of: categorical features associated with the users; categorical features associated with the items; dense features associated with the users; dense features associated with the items; text data associated with inputs of the users; text data associated with the items; image data associated with the items; and image data associated with the users. In one example, categorical features associated with the users includes occupations of the users. In one example, categorical features associated with the items includes product categories of the items. In one example, dense features associated with the users includes ages of the users. In one example, text data associated with inputs of the users includes reviews and/or comments inputted by the users on the items. In one example, text data associated with the items includes titles and/or description of items. In one example, image data associated with the items includes images of the items. In one example, image data associated with the users includes images (or image data) provided by the users.

Optionally, step (b1) comprises: processing categorical features associated with the users and/or categorical features associated with the items by performing a one-hot embedding operation.

Optionally, step (b1) comprises: processing dense features associated with the users and/or dense features associated with the items by performing a normalization operation.

Optionally, step (b1) comprises: processing text data associated with inputs of the users and/or text data associated with the items using a transformer-based machine learning model. In one example, the transformer-based machine learning model comprises a BERT-based model, e.g., a Sentence-BERT model.

Optionally, step (b1) comprises: processing image data associated with the items and/or image data associated with the users using a convolutional neural network. In one example the convolutional neural network comprises ResNet.

Optionally, step (b1) comprises: processing categorical features associated with the users and/or categorical features associated with the items by performing a one-hot embedding operation; processing dense features associated with the users and/or dense features associated with the items by performing a normalization operation; processing text data associated with inputs of the users and/or text data associated with the items using a transformer-based machine learning model; processing image data associated with the items and/or image data associated with the users using a convolutional neural network; and processing the processed categorical features, the processed dense features, the processed text data, and the processed image data using a feature crossing network and a self attention mechanism to obtain the contextual vector representations.

Optionally, step (c1) comprises: selecting at least some of the items that the user has interacted with; processing, based on a concatenation operation, the one or more collaborative vector representations associated with the at least some items that the user has interacted with and the collaborative vector representation associated with the item which the user has not interacted with; processing data obtained after the concatenation operation using a multilayer perceptron and a softmax function to obtain attention weights; and applying the attention weights to the collaborative vector representations associated with the one or more items that the user has interacted with to obtain the user interest vector representation.

Optionally, the selecting includes selecting one or more most recent items that the user has interacted with.

Optionally, the applying includes multiplying the attention weights with the collaborative vector representations associated with the one or more items that the user has interacted with to obtain the user interest vector representation.

Optionally, step (c2a) comprises: determining first feature vector representations associated with interactions between the contextual vector representations and the user interest vector representation.

Optionally, step (c2a) comprises: determining second feature vector representations associated with interactions between the collaborative vector representations and the user interest vector representation.

Optionally, in step (c3) the multilayer perceptron is a tower shaped multilayer perceptron.

Optionally, the method further comprises: outputting the recommendation to the user. Optionally, the outputting comprises: providing a list containing one or more items in the recommendation to the user.

Optionally, the items comprise media or multimedia items. For example, the media or multimedia items include one or more of: a media product, a multimedia product, a video (e.g., movie), an audio item (e.g., music, song, etc.), an image, and a text (e.g., book, e-book, webpage), a game (e.g., computer game), etc.

Optionally, the media or multimedia items are for use or operation on a mobile or edge device. The mobile or edge device may be any mobile or edge computing devices such as mobile phone (smart phone), tablet, laptop, desktop, etc.

In a second aspect, there is provided a recommender system, comprising: one or more processors; and memory storing one or more programs configured to be executed by the one or more processors, the one or more programs including instructions for performing the method of the first aspect. The optional features in the first aspect are also applicable as optional features in the second aspect. The recommender system may include an interface for communicating information and data, and an input/output means (e.g., display) for providing a user interface for receiving user input and/or providing information to the user.

In a third aspect, there is provided a non-transitory computer-readable storage medium storing one or more programs configured to be executed by one or more processors, the one or more programs including instructions for performing the method of the first aspect. The optional features in the first aspect are also applicable as optional features in the third aspect.

In a fourth aspect, there is provided an information handling system (e.g., computing device) comprising means for carrying out the method of the first aspect. The optional features in the first aspect are also applicable as optional features in the fourth aspect.

In a fifth aspect, there is provided a computer program comprising instructions which, when the program is executed by one or more processors, cause the one or more processors to carry out the method of the first aspect. The optional features in the first aspect are also applicable as optional features in the third aspect.

In a sixth aspect, there is provided a computer program product comprising the computer program of the fifth aspect.

Other features and aspects of the invention will become apparent by consideration of the detailed description and accompanying drawings. Any feature(s) described herein in relation to one aspect or embodiment may be combined with any other feature(s) described herein in relation to any other aspect or embodiment as appropriate and applicable.

### BRIEF DESCRIPTION OF THE DRAWINGS

Embodiments of the invention will now be described, by way of example, with reference to the accompanying drawings in which:

FIG. 1 is a flowchart illustrating a method for operating a recommender system in one embodiment;

FIG. 2 is a flowchart illustrating a method for operating a recommender system in one embodiment;

FIG. 3 is a schematic diagram of a recommender system in one embodiment;

FIG. 4 is a schematic diagram illustrating operation of a graph embedding module in the recommender system of FIG. 3 in one embodiment;

FIG. 5 is a schematic diagram illustrating operation of a contextual information extraction module in the recommender system of FIG. 3 in one embodiment;

FIG. 6 is a schematic diagram illustrating operation of a user interest modelling module in the recommender system of FIG. 3 in one embodiment;

FIG. 7A is a graph showing performance of a recommender system in one embodiment using the “Movielens” dataset and under different random walk length (applied in the random-walk based graph embedding method in the recommender system);

FIG. 7B is a graph showing performance of a recommender system in one embodiment using the “Kaggle” dataset and under different random walk length (applied in the random-walk based graph embedding method in the recommender system); and

FIG. 8 is a functional block diagram of an information handling system that is arranged to perform at least some of the recommender system operations in some embodiments and/or to operate as at least part of a recommender system in some embodiments.

### DETAILED DESCRIPTION

The inventors of the present invention have realized, through research, that context-aware recommendation is a popular research direction for some time as it utilizes contextual information (such as time, location, social relationship data, and environmental data) to facilitate the recommendation and ease the data sparsity and cold-start problems. The inventors of the present invention are aware that contextual recommendations span from early works with feature engineering techniques to extract categorical and dense features, like movie or new recommendations, to recent trends of location and social behavior based PoI recommendations and resource-aware mobile application recommendations. The inventors of the present invention have devised, through research, that: Feature interaction and user interest modeling are two commonly used methods to incorporate contexts in context-aware recommendations. Factorization machines (FM) and its deep learning versions, such as DeepFM, convolutional FM (CFM) and deep cross network (DCN), are able to capture the interactions between different input features and embed them into a low-dimensional latent space. Interest modeling, e.g., deep interest network (DIN), deep interest evolution network (DIEN), and deep session interest network (DSIN), enables the incorporation of various contextual features and adopts an attention mechanism to model users' interests based on these features and user-item interactive behaviors. The inventors of the present invention have devised, through research, experiments (e.g., simulations), and/or trials, that these existing methods do not specifically deal with the rapid context-drifting problem. The inventors of the present invention have devised, through research, experiments (e.g., simulations), and/or trials, that it would help to disentangle the relative static user-item interactions and the more dynamic contexts to provide improved methods.

On the other hand, the inventors of the present invention have realized, through research, that graph-based models have recently attracted more attention in recommendations to extract higher-order relations between users and items due to its ability to capture multi-hop relations in the graph. The inventors of the present invention have realized, through research, various examples of such models: (1) A neural graph collaborative filtering (NGCF) method employs a 3-hop graph neural network to learn user and item embeddings from the user-item bipartite graph, as disclosed in Xiang Wang, Xiangnan He, Meng Wang, Fuli Feng, and Tat-Seng Chua. 2019. Neural graph collaborative filtering. In Proceedings of the 42nd international ACM SIGIR conference on Research and development in Information Retrieval. (2) LightGCN, as disclosed in Xiangnan He, Kuan Deng, Xiang Wang, Yan Li, Yongdong Zhang, and Meng Wang. 2020. Lightgcn: Simplifying and powering graph convolution network for recommendation. In Proceedings of the 43rd International ACM SIGIR conference on research and development in Information Retrieval. 639-648., which further improves NGCF by removing the feature transformation and nonlinear activation operation that contribute little to the model performance. (3) PinSage, as disclosed in Rex Ying, Ruining He, Kaifeng Chen, Pong Eksombatchai, William L Hamilton, and Jure Leskovec. 2018. Graph convolutional neural networks for web-scale recommender systems. In Proceedings of the 24th ACM SIGKDD International Conference on Knowledge Discovery & Data Mining. 974-983, which utilizes a 2-hop graph convolutional neural network and random walk to facilitate the representation learning. (4) MGCN, as disclosed in Yinwei Wei, Xiang Wang, Liqiang Nie, Xiangnan He, Richang Hong, and Tat-Seng Chua. 2019. MMGCN: Multi-modal graph convolution network for personalized recommendation of micro-video. In Proceedings of the 27th ACM International Conference on Multimedia. 1437-1445, which proposes a graph convolutional network to learn representations from the multimodal information in multi-media recommendations. (5) A random walk based graph embedding method, as disclosed in Weijing Chen, Weigang Chen, and Linqi Song. 2020. Enhancing Deep Multimedia Recommendations Using Graph Embeddings. In 2020 IEEE Conference on Multimedia Information Processing and Retrieval (MIPR). IEEE, 161-166, for extracting high-order collaborative signals from the user-item bipartite graph. (6) Graph neural networks introduced to model user's local and global interest for recommendations, as disclosed e.g., in Shu Wu, Yuyuan Tang, Yanqiao Zhu, Liang Wang, Xing Xie, and Tieniu Tan. 2019. Session-based recommendation with graph neural networks. In Proceedings of the AAAI Conference on Artificial Intelligence, Vol. 33. 346-353, Chengfeng Xu, Pengpeng Zhao, Yanchi Liu, Victor S Sheng, Jiajie Xu, Fuzhen Zhuang, Junhua Fang, and Xiaofang Zhou. 2019. Graph Contextualized Self-Attention Network for Session-based Recommendation. In IJCAI, Vol. 19. 3940-3946, and Feng Yu, Yanqiao Zhu, Qiang Liu, Shu Wu, Liang Wang, and Tieniu Tan. 2020. TAG1VN: Target attentive graph neural networks for session-based recommendation. In Proceedings of the 43rd International ACM SIGIR Conference on Research and Development in Information Retrieval. 1921-1924. Nonetheless, the inventors of the present invention have realized that incorporating a large amount of drifting contextual information into the graph based models would lead to an exploding number of nodes (user/item-context concatenation) in the graph, posing difficulties in learning and re-training. In light of this, the inventors of the present invention have realized that a specifically designed solution is needed to disentangle user-item interactions and contexts and a more comprehensive design is needed to combine these embeddings learned from different information sources.

The inventors of the present invention have further devised, through research, that with the proliferation of mobile edge devices, contextual information is explored to show its impact in recommender systems, especially towards personalized recommendations. The inventors have realized that compared to traditional context-aware recommendations with commonly-used contextual information of time, location, companion, and environmental situation, these recent contextual recommendations focus more on features from mobile and edge devices. One example is to recommend Point of Interest (PoI) based on location, weather, and social behavior. Another example is to recommend mobile application based on the mobile device's resources and usage levels, such as computing power, communication capacity, battery levels, etc.

The inventors of the present invention have devised, through research, that in these emerging contextual recommendations, contexts are often drifting rapidly and user-item interactions are relatively stable. For example, in a mobile game recommendation scenario, contextual features like locations, battery power level, and memory storage leves of mobile devices are frequently changing over time and there may be different versions of mobile application (e.g., game) tailor-made for different mobile resources, while the user's rating behavior over the mobile application (e.g., game) is sparse and relatively static. The inventors of the present invention have devised, through research, experiments (e.g., simulations), and/or trials, that graph-based deep learning techniques have been used in recommendations but there are deficiencies. Some of these graph-based methods focus on the user-item interaction and fail to properly or fully exploit the contextual information (or even neglect the contextual information). Some other works do not take into account the drifting of contextual information and may cause prohibitively high computation complexity or sparsity problems (e.g., the number of nodes being in the order of user/item-context concatenation pairs) in graph-based solutions when the space of drifting contextual information grows large. The inventors of the present invention have realized that these existing recommendation methods/systems may not be suitable for computing resource constrained mobile devices and edge devices in the Artificial Intelligent of Things (AIoT) systems.

Against this background, the inventors of the present invention have devised, through research, experiments (e.g., simulations), and trials, a graph based solution for context-drifting recommendations. In one embodiment, as further described below, the solution is referred to as a Hybrid Static and Adaptive Graph Embedding (HySAGE) network. The graph based solution adopts a hybrid structure to learn different embeddings for relatively static user-item interaction and rapidly drifting contextual information. By decoupling the adaptive representation of contextual information and the static representation of user-item interaction, the graph based solution is particularly suitable for context-drifting recommendations. In this way, the drifted contextual attributes would pass through the embedding layer via interactive attention mechanisms and there is no need to re-train the whole graph. Therefore, using such a hybrid structure could potentially save the computation resources and re-training time.

Some embodiments of the invention, which address one or more of the above-disclosed problems, will now be presented below.

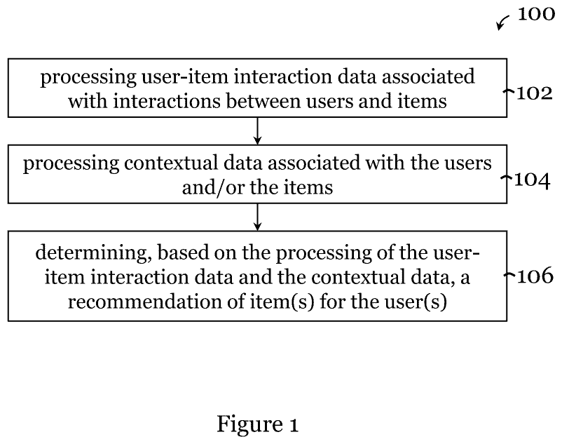

FIG. 1 illustrates a high-level method too for operating a recommender system in one embodiment. The method too is a computer-implemented method. The method too includes, in step 102, processing user-item interaction data associated with interactions between users and items. The method 100 also includes, in step 104, processing contextual data associated with the users and/or the items. After steps 102 and 104 are performed, then in step 106, the method 100 includes determining, based on the processing of the user-item interaction data and the contextual data, a recommendation of at least one of the items for at least one of the users. The item(s) recommended to the users are item(s) that the users have not interacted with previously. In this embodiment the user-item interaction data changes less frequently over time than the contextual data. Depending on the embodiments, step 102 can be performed before step 104, after step 104, or substantially simultaneously as step 104.

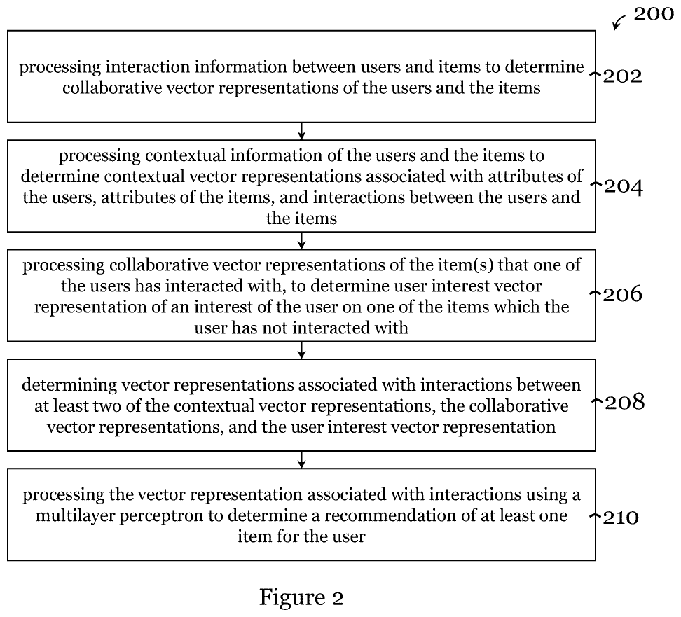

FIG. 2 illustrates a method 200 for operating a recommender system in one embodiment. The method 200 can be considered as a specific implementation of the method 100 of FIG. 1 in one embodiment. The method 200 is a computer implemented method.

The method 200 includes, in step 202, processing interaction information between users and items to determine collaborative vector representations of the users and the items. Step 202 can be considered as a specific implementation of step 102 in the method 100 of FIG. 1. In one embodiment, the interaction information between users and items comprises a user-item interaction bipartite graph. The graph includes two sets, one user set with the users and one item set with the items. At least some of the users are connected with at least some of the times with edges. The edges may be associated with a weight or weighing factor.

In one embodiment, step 202 includes processing the user-item interaction bipartite graph to determine information associated with similarities of the users and information associated with similarities of the items. The information associated with similarities of the users may include a user similarity graph associated with the users, and the user similarity graph may include multiple nodes each associated with a respective one of the users. The user similarity graph may be a representation of a user similar matrix. The user similarity graph may be a representation of a user similar matrix. The information associated with similarities of the items may include an item similarity graph associated with the items, and the item similarity graph includes multiple nodes each associated with a respective one of the items. The item similarity graph may be a representation of an item similar matrix. The item similarity graph may be a representation of the item similar matrix.

In one embodiment, step 202 further includes processing the item similarity graph using a graph embedding method to obtain item nodes sequence; and processing the user similarity graph using a graph embedding method to obtain user nodes sequence, and processing the item similarity graph using a graph embedding method to obtain item nodes sequence; and processing the user similarity graph using a graph embedding method to obtain user nodes sequence. The graph embedding method used for processing the item similarity graph may include random-walk based graph embedding method. The graph embedding method used for processing the user similarity graph may include random-walk based graph embedding method.

In one embodiment, step 202 further includes processing the item nodes sequence using a co-occurrence based method to determine the collaborative vector representations of items, and processing the user nodes sequence using a co-occurrence based method to determine the collaborative vector representations of users.

The method also includes, in step 204, processing contextual information of the users and the items to determine contextual vector representations associated with attributes of the users, attributes of the items, and interactions between the users and the items. Step 204 can be considered as a specific implementation of step 102 in the method too of FIG. 1.

In one embodiment, the contextual information of the users and the items includes at least some of: categorical features associated with the users; categorical features associated with the items; dense features associated with the users; dense features associated with the items; text data associated with inputs of the users; text data associated with the items; image data associated with the items; and image data associated with the users. In one example, categorical features associated with the users includes occupations of the users. In one example, categorical features associated with the items includes product categories of the items. In one example, dense features associated with the users includes ages of the users. In one example, text data associated with inputs of the users includes reviews and/or comments inputted by the users on the items. In one example, text data associated with the items includes titles and/or description of items. In one example, image data associated with the items includes images of the items. In one example, image data associated with the users includes images (or image data) provided by the users.

In one embodiment, depending on the information of the users and the items available, step 204 includes: processing categorical features associated with the users and/or categorical features associated with the items by performing a one-hot embedding operation; processing dense features associated with the users and/or dense features associated with the items by performing a normalization operation; processing text data associated with inputs of the users and/or text data associated with the items using a transformer-based machine learning model (e.g., a BERT-based model such as Sentence-BERT model); and/or processing image data associated with the items and/or image data associated with the users using a convolutional neural network (e.g., ResNet).

In one embodiment, depending on the information of the users and the items available, step 204 further includes: processing the processed categorical features, the processed dense features, the processed text data, and/or the processed image data using a feature crossing network and a self-attention mechanism to obtain the contextual vector representations.

The method also includes, in step 206, processing processing collaborative vector representations of the item(s) that one of the users has interacted with, to determine user interest vector representation of an interest of the user on one of the items which the user has not interacted with. Step 206 can be considered as a specific implementation of part of step 106 in the method 100 of FIG. 1.

In one embodiment, step 206 includes: selecting at least some of the items that the user has interacted with; processing, based on a concatenation operation, the one or more collaborative vector representations associated with the at least some items that the user has interacted with and the collaborative vector representation associated with the item which the user has not interacted with; processing data obtained after the concatenation operation using a multilayer perceptron and a softmax function to obtain attention weights; and applying the attention weights to the collaborative vector representations associated with the one or more items that the user has interacted with to obtain the user interest vector representation. The selection may include selecting one or more most recent items that the user has interacted with. The applying may include multiplying the attention weights with the collaborative vector representations associated with the one or more items that the user has interacted with to obtain the user interest vector representation. Step 206 may be repeated for multiple items that the user has not interacted with.

After steps 202, 204, and 206, the method 200 includes, in step 208, determining vector representations associated with interactions between at least two of the contextual vector representations, the collaborative vector representations, and the user interest vector representation. Step 208 can be considered as a specific implementation of part of step 106 in the method 100 of FIG. 1.

In one embodiment, step 208 includes determining vector representations associated with local interactions between at least two of the contextual vector representations, the collaborative vector representations, and the user interest vector representation; and determining vector representation associated with global interactions based on the vector representations associated with local interactions, the contextual vector representations, the collaborative vector representations, and the user interest vector representation. The determining of vector representations associated with local interactions may include determining first feature vector representations associated with interactions between the contextual vector representations and the user interest vector representation, as well as determining second feature vector representations associated with interactions between the collaborative vector representations and the user interest vector representation.

After step 208, in step 210, the method 200 includes processing the vector representation associated with interactions using a multilayer perceptron to determine a recommendation of at least one item for the user. Step 210 can be considered as a specific implementation of part of step 106 in the method 100 of FIG. 1. In one embodiment, the multilayer perceptron is a tower shaped multilayer perceptron.

Although not illustrated, the method 200 may further include outputting the recommendation to the user, e.g., by providing a list containing one or more items in the recommendation to the user.

The skilled person appreciates that various modifications can be made to the method 200 to provide other embodiments of the invention. For example, depending on the embodiments, step 202 can be performed before step 204, after step 204, or substantially simultaneously as step 204. For example, depending on the embodiments, step 206 is performed after step 202 and can be performed before, after, or substantially simultaneously as step 204.

In some embodiments, the items in methods 100, 200 are media or multimedia items, which may be: a media product, a multimedia product, a video (e.g., movie), an audio item (e.g., music, song, etc.), an image, and a text (e.g., book, e-book, webpage), a game (e.g., computer game), etc. In some embodiments, the items in methods 100, 200 are for use or operation on a mobile or edge computing devices such as mobile phone (smart phone), tablet, laptop, desktop, etc.

In one embodiment of the invention, there is provided a HySAGE network. The HySAGE network may be considered as a specific implementation of the methods 100, 200. In the HySAGE network, user and item relations (e.g., the rating matrix) are used to construct a bipartite graph and obtain user and item similarity graphs. Then, a co-occurrence and random walk-based graph embedding algorithm is applied to exploit user and item collaborative embeddings respectively. On the other hand, multimodal contextual information is incorporated via various embedding techniques, like specific pre-trained models for texts and images (e.g., Sentence-BERT and ResNet), pre-processing techniques (e.g., normalization and feature crossing) for other categorical and/or dense contextual features. In one embodiment, to reduce the feature dimensionality and learn the feature interaction, the generated feature vectors are fed into the feature crossing layer to learn the higher-order non-linear feature interactions. After obtaining the extracted graph embedding and contextual embedding, the self-attention mechanism can be used to model the user interests. Instead of the average pooling, the attention mechanism can learn the importance of each component and assign different weights to the components accordingly. As a result, all the representations from different sources can be combined to acquire the final representation for users and items. Finally, these representations are fed into a multi-layer perception to predict the final ratings.

Some of the aspects of this disclosure relates to the following. In one aspect, to effectively learn the fast changing contextual information and relative static user-item interaction, some embodiments have provided an end-to-end HySAGE network for context-drifting recommendations, in which graph embedding module is combined with contextual feature extraction module and user interest mining module to generate a comprehensive representation from different sources. In another aspect, advanced techniques are applied to better learn the comprehensive representation: a co-occurrence and random walk-based graph embedding technique to extract both global statistical information and local graph information to obtain user and item embeddings accordingly; a multimodal processing technique for jointly exploring multimodal contextual information and other categorical and dense features; a self-attention mechanism to learn the user interest from both the graph embedding and the contextual information embedding; and an interactive attention mechanism to combine different representations into a comprehensive representation. In yet another aspect, extensive experiments are performed using the HySAGE network on four real-world datasets to demonstrate the effectiveness of HySAGE network method (up to 20%-30% gains over benchmarks) and its importance in incorporating contextual information and user interest.

The following description relates to one specific implementation of the HySAGE network/method. The skilled person appreciates that modification can be made to the disclosure to provide other embodiments of the invention.

In one embodiment, there is provided a dynamic context-drifting recommender system that consists of N users and M items, with the sets of users and items denoted as [symbol] ={u₁, . . . u_{N}} and [symbol] ={i₁, . . . , i_{M}}, respectively. Different from problem formulation of static recommendations, this embodiment consider a time horizon of T time slots.

In terms of attributes, at each time slot t∈{1, . . . , T}, the attribute of each user uₙ∈ [symbol] is denoted by a vector aᵤ_{ₙ}(t)∈ [symbol] ^{d}^{_{U}}, and the attribute of each item iₘ∈ [symbol] by a vector aᵢ_{ₘ}(t)∈ [symbol] ^{d}^{_{I}}. In this way, the drifting contexts associated with users and/or items can be modeled: user attributes (e.g., locations, battery levels of the device) and item attributes (e.g., freshness of content, item descriptions).

In terms of user-item interactions, over the course of T time slots, a user uₙ may have interaction with item iₘ at time t and generate multi-modal information (e.g., texts, images, and/or videos from reviewing the item). In this embodiment, denote the contextual information by a vector cᵤ_{ₙ}ᵢ_{ₘ}(t)∈ [symbol] ^{d}^{_{C}}. At the end of T time slots, the matrix Y∈{0,1}^{N×M} is used to summarize the user-item interactions, where Yₙₘ=1 if user uₙ has interaction with item iₘ is observed and Yₙₘ=0 otherwise. Note that this interaction matrix can be relaxed by allowing Yₙₘ∈ [symbol] to reflect multiple interactive behaviors (like the frequency of listening to some music).

In terms of user interests, each user u n has time-varying interests in each item iₘ, denoted by a vector θᵤ_{ₙ}ᵢ_{ₘ}(t)∈ [symbol] ^{d}^{_{I}}.

In terms of rating, this embodiment aims to learn the users' ratings of the items at time t based on all the information available up to time t. The collection of attributes, contextual information, and user interests up to time t can be expressed by aᵤ_{ₙ}[1:t], aᵢ_{ₘ}[1:t], cᵤ_{ₙ}ᵢ_{ₘ}[1:t], and θᵤ_{ₘ}ᵢ_{ₘ}[1:t], respectively. More specifically, user uₙ's rating of item iₘ at time t are modelled as follows

Rₜ(eᵤ_{ₙ},eᵢ_{ₘ},aᵤ_{ₙ}(t),aᵢ_{ₘ}(t),cᵤ_{ₙ}iₘ[1:t],θᵤ_{ₙ}iₘ(t)) (1)

where eᵤ_{ₙ} and eᵢ_{ₘ} are vectors representing user uₙ and item iₘ. Note that instead of indices n and m, vectors eᵤ_{ₙ} and eᵢ_{ₘ} are used to represent the user and the item, because more useful information can be encoded into the vectors.
Based on the model (1), in this embodiment, the following components are required:
(i) Static embeddings of user and item identities eᵤ_{ₙ} and eᵢ_{ₘ}.
   This is obtained a graph embedding algorithm that captures user-item interactions as well as user and item similarities, and produces static embeddings.
(ii) Adaptive embeddings of time-varying user and item attributes aᵤ_{ₙ}(t) and aᵢ_{ₘ}(t), and contextual information of user-item interactions (t).
   The attributes and contextual information can include multimodal information such as numbers, texts, and images. Therefore, a contextual information extraction module can be used to fusion multimodal information into vectors. Note that the embeddings are time-varying, capturing drifting attributes and contextual information.
(iii) Estimation of time-varying user interests θᵤ_{ₙ}(t).
   Based on user and item attributes aᵤ_{ₙ}[1:t] and aᵢ_{ₘ}[1:t], and contextual information of user-item interactions cᵤ_{ₙ}ᵢ_{ₘ}[1:t], the user interests θᵤ_{ₙ}ᵢ_{ₘ}(t) can be estimated
(iv) Estimation of user ratings Rₜ in (1).
   User ratings can be estimated based on all available information.

In some embodiments, the proposed framework is an end-to-end method that combines all four components. In some embodiments, the resulting recommendation algorithm is context-aware and interest-aware, which boosts the performance. Moreover, In some embodiments, the resulting recommendation algorithm reduces the computational complexity by decoupling the static graph embeddings and the adaptive embeddings of attributes, context, and user interests. In this way, it avoids repeated training of graph embeddings while still capturing all available information.

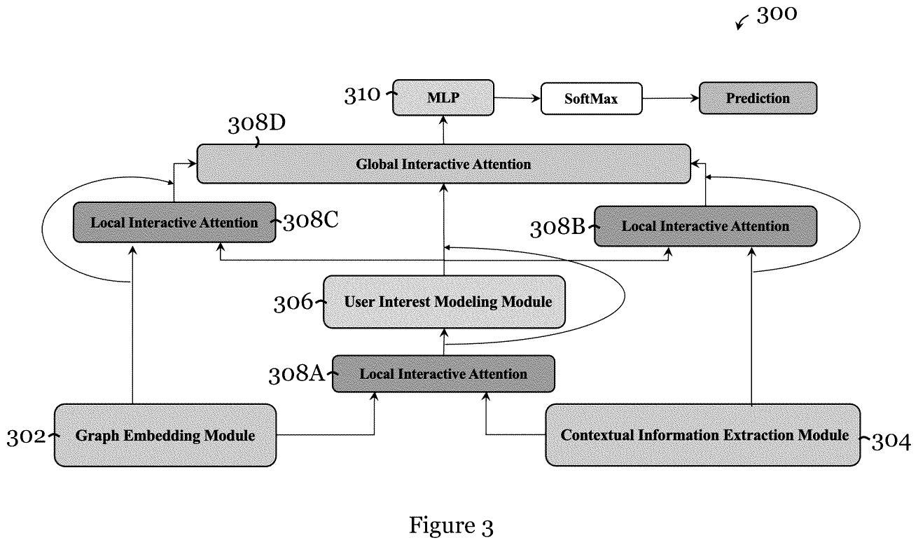

One embodiment of the proposed framework is referred to as HySAGE, a Hybrid Static and Adaptive Graph Embedding for dynamic recommendation. FIG. 3 illustrates the framework or system 300 in one embodiment, which includes, at least: a graph embedding module 302, a contextual information extraction module 304, a user interest modeling module 306, and an interactive attention module 308A-D.

In one embodiment, HySAGE operates in the following steps to perform the recommendation. First, static graph embeddings of users and items are learned by building the user and item bipartite network and mining their high-order collaborative embeddings. Second, adaptive embeddings of contextual information about user-item interaction are obtained through (i) representing drifting user and item attributes, (ii) adopting pre-trained neural networks to extract multimodal user-item interaction information (e.g., audio, image, text), and (iii) using a feature crossing layer to fusion user and item attributes and user-item interaction information, compress the dimension, reduce redundancy and learn high-level feature interactions. Third, attention mechanism is used to model the users' recent interests. Fourth, local interactive attention mechanisms are used to extract bilateral interactions among static graph embeddings, adaptive embeddings of user-item interactions, and adaptive user interests, and a global interactive attention mechanism is used to learn the final representations from individual embeddings and their bilateral interactions. Finally, a trained multilayer perceptron (MLP) 310 is used to predict the users' ratings of the items.

Referring to FIG. 3, in this embodiment, the graph embeddings for users and items are first learned by co-occurrence and random walk-based techniques. Based on the learned graph embeddings, an attention mechanism is applied to learn the users' interests. Besides, features are extracted from contextual information by pre-trained models and use a feature crossing network and an attention layer to learn the hidden representation of contextual information. All of these are concatenated, go through a global interactive attention layer, and are fed to the MLP to get the final recommendation.

Various major components of the system 300 will now be described.

### Graph Embedding Module 302

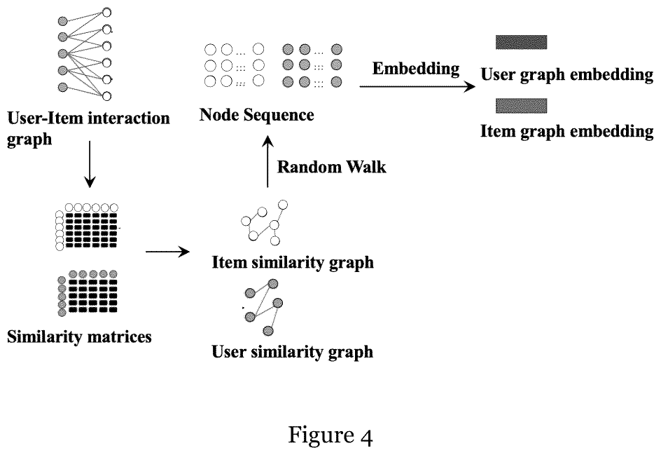

An embodiment of the operation of the graph embedding module 302 is shown in FIG. 4. The graph embedding module 302 builds the user and item similarity graphs and learns static graph embeddings eᵤ_{ₙ} and eᵢ_{ₘ} for each user uₙ∈ [symbol] and each item iₘ∈ [symbol] .

In one embodiment the graph embedding module 302 is arranged to build user/item similarity graphs. In this embodiment, user and item similarity matrices are calculated (preferably solely) based on the interactions Y between users and items. The user similarity matrix is a N×N matrix, with each element being a co-interaction value between two users. The item similarity matrix is a M×M matrix, with each element being a co-interaction value between two items. In this embodiment the definition of the co-interaction value between two users is the number of items they both interacted with, and that between two items is the number of users who interacted with both of them. Mathematically, the user similarity matrix can be calculated as:

S^{U}=Y·Y^{T}∈ [symbol] ^{N×N} (2)

and the item similarity matrix can be calculated as:

S^{I}=Y^{T}·Y∈ [symbol] ^{M×M}. (3)

In some other embodiments, the framework can use other definitions of co-interaction values, such as Pearson correlation, cosine distance, and Jaccard similarity.

In one embodiment the user similarity matrix defines a user similarity graph [symbol] _{U}, with the set of the nodes as the user set [symbol] . There exists an edge between user uₙ and user uₗ if their co-interaction value sₙₗ^{U} (i.e., the (n,l)-th element of the user similarity matrix S^{U}) is non-zero (i.e., the two users have interacted with the same item). The weights of the edges are defined as the corresponding co-interaction values. The item similarity graph [symbol] can be defined in the same way.

In one embodiment, The co-interaction value between two users is the number of items they co-interacted with, and co-interaction value between two items is the number of users co-consumed them. Y is the user-item interaction matrix, let M^{u} denotes the user-user co-interaction matrix, or user-user similarity matrix. The co-interaction value between two users u, i can be computed as:

Mᵤᵢ^{u}=yᵤ*yᵢ^{T}

where yᵤ and yᵢ are rows of Y. Also, the co-interaction value between two items can be computed in the same way. So, a user similarity matrix and an item similarity matrix can be computed by multiplying the user-item interaction matrix with its transpose using matrix calculations:

M^{u}=Y*Y^{T},Mⁱ=Y^{T}*Y.

Finally two similarity matrices are obtained: item similarity matrix Wⁱ and user similarity matrix M^{u} and these two matrices can be viewed as the adjacent matrices of two graphs: a user similarity graph G^{u} and an item similarity graph Gⁱ. These two graph brings useful collaborative information that is extracted from user-item interactions.

In one embodiment the graph embedding module 302 is arranged to mine collaborative information. Based on user and item similarity graphs, collaborative information can be mined using graph embedding techniques. Deep learning based graph embedding techniques can be applied for this purpose, as they can extract node and edge features.

To capture the structures of a graph, the graph embedding technique in this embodiment simulate a random walk process to create node sequences. The process to generate user sequences based on the user similarity graph is described below. The item sequences are generated in the same way hence will not be further described.

Denote the user sequence of a fixed length K by {uₙ_{₁}, . . . , uₙ_{ₖ}, . . . , uₙ_{_{K}}}. Given the kth node uₙ_{ₖ}, the next node uₙ_{ₖ₊₁} is randomly selected from node uₙ_{ₖ}'s neighbors according to the following probabilities:

$$P ( {u}_{{n}_{k + 1}} \vert {u}_{{n}_{k}} ) ∝ \{ \begin{matrix}{s}_{{n}_{k} {n}_{k + 1}}^{U} / p , & if {u}_{{n}_{k + 1}} = {u}_{{n}_{k - 1}} \\ {s}_{{n}_{k} {n}_{k + 1}}^{U} , & if {u}_{{n}_{k + 1}} is a neighbor of {u}_{{n}_{k - 1}} \\ {s}_{{n}_{k} {n}_{k + 1}}^{U} / q , & otherwi s e\end{matrix} \qquad ( 4 )$$

with p, q>0. In other words, the next node is chosen with a probability proportional to the similarity to the current node (measured by the co-interaction value sₙ_{ₖ}ₙ_{ₖ₊₁}^{U}), moderated by parameters p, q. For example, p>1 can be chosen to discourage the selection of the previous node uₙ_{_{k−1}} and q<1 to encourage the selection of nodes that are not neighbors of the previous node uₙ_{_{k−1}}. As can be seen from (4), a user more similar to the current node, as measured by a higher co-interaction value, is more likely to be selected as the next node in the sequence. Hence, this sampling process helps to better capture collaborative information.

Given all the K-node sequences, the global co-occurrence based method disclosed in Jeffrey Pennington, Richard Socher, and Christopher Manning. 2014. Glove: Global vectors for word representation. In Proceedings of the 2014 Conference on Empirical Methods in Natural Language Processing (EMNLP). 1532-1543 can be used to learn the user embeddings eᵤ_{ₙ}. The co-occurrence between two users uₙ and uₗ, denoted Oₙₗ, is defined as the empirical frequency of these two users appearing in the same user sequence. The user embeddings are used to estimate the co-occurrence according to:

Ôₙₗ=exp(eᵤ_{ₙ}^{T}\tilde{e}ᵤ_{ₗ}+bᵤ_{ₙ}+\tilde{b}ᵤ_{ₗ}), (5)

where bᵤ_{ₙ}∈ [symbol] is the bias, \tilde{e}ᵤ_{ₗ} and \tilde{b}ᵤ_{ₗ} are the embedding and the bias of nodes uₗ when node uₗ appears second in a two-node pair. Note that the embedding and the bias of node uₗ when it appears first in a two-node pair are eᵤ_{ₗ} and bᵤ_{ₗ}.

One embodiment of the invention aims to learn the user embeddings eᵤ_{ₙ} and \tilde{e}ᵤ_{ₙ} that minimize the discrepancy between the estimated co-occurrence Ôₙₗ and the actual co-occurrence Oₙₗ. The loss function of the training process can be defined as:

$$\begin{matrix}{ℒ}^{G E} ( {e}_{{u}_{1}} , … , {e}_{{u}_{N}} , {b}_{{u}_{1}} , … , {b}_{{u}_{N}} ) = {\sum }_{( {u}_{n} , {u}_{l} )} {( log {\hat{O}}_{n l} - log {O}_{n l} )}^{2} \\ = {\sum }_{( {u}_{n} , {u}_{l} )} {( {e}_{{u}_{n}}^{⊤} {\tilde{e}}_{{u}_{l}} + {b}_{{u}_{n}} + {\tilde{b}}_{{u}_{l}} - log {O}_{n l} )}^{2}\end{matrix} . \qquad ( 6 )$$

The training process can be performed by a two-layer neural network whose input is one-hot embedding of the user nodes. After the training, in one embodiment, set eᵤ_{ₙ}←eᵤ_{ₙ}+\tilde{e}ᵤ_{ₙ}.

It should be noted that although static graph embeddings of the users and items are used, in some embodiments the framework can update the graph embeddings through graph convolution as disclosed in Thomas N Kipf and Max Welling. 2016. Semi-supervised classification with graph convolutional networks. arXiv preprint arXiv:1609.02907 (2016).

### Contextual Information Extraction Module 304

In one embodiment, the contextual information extraction module 304 learns the adaptive embeddings of drifting user and item attributes aᵤ_{ₙ}(t), aᵢ_{ₘ}(t) and user-item interactions cᵤ_{ₙ}ᵢ_{ₘ}(t). These adaptive embeddings can be obtained from multimodal information (e.g., categorical, numerical, textual, image). Based on the embeddings, the module uses a feature crossing layer and the attention mechanism (layer) for better representation learning of the feature interaction.

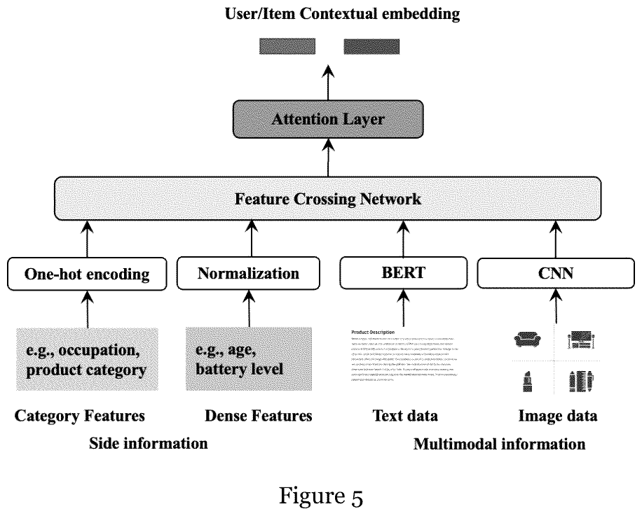

FIG. 5 illustrates operation of the contextual information extraction module 304 in one embodiment.

In terms of category features, some of the user and item attributes are categorical data (e.g., occupations of the users, product categories of the items). IN this respect, one embodiment of the invention uses one-hot embedding of the categorical data initially, and feeds the sparse one-hot vectors to the feature crossing layer to obtain dense vectors later.

In terms of dense features, in one embodiment, dense features (e.g., user ages) are normalized using min-max scalers and then fed into the feature crossing layer.

In terms of text data, in one embodiment, text data (e.g., titles and description of items, review by the users) contains critical information. A pre-trained model called Sentence-BERT, as disclosed in Nils Reimers and Iryna Gurevych. 2019. Sentence-ben: Sentence embeddings using siamese bert-networks. arXiv preprint arXiv:1908.10084 (2019), can be used to process the raw data and get fixed-length vectors as output.

In terms of image data, in one embodiment, image data (e.g., display images of items, pictures uploaded by the users) contains crucial hidden information. Due to the high dimensionality of raw images, a pre-trained convolutional neural network (CNN), e.g., ResNet as disclosed in Kaiming He, Xiangyu Zhang, Shaoging Ren, and Jian Sun. 2016. Deep residual learning for image recognition. In Proceedings of the IEEE conference on computer vision and pattern recognition. 770-778, can be used to process the images and get fixed-length vectors as output.

Like text data, the image data is too large and noisy to input into the model directly. Thus, in one embodiment, instead of the whole image, the feature(s) are extracted from the image. A pre-trained model is adapted to process the original image and get the feature vector. More precisely, a convolutional neural network (CNN) is adopted to extract the image. Suitable pre-trained CNN models include, e.g., VGG, Resnet, and Alexnet trained on ImageNet. In one embodiment, for the whole process, the image is first preprocessed by resizing and normalizing it, then it is sent to a pre-trained CNN model to obtain a fixed-length feature vector as output. The image feature could be fused with other models for better representation learning.

After one-hot embedding of categorical features, preprocessing of dense features, and embedding of text and image data, embeddings of user and item attributes aᵤ_{ₙ}(t), aᵢ_{ₘ}(t) and user-item interactions cᵤ_{ₙ}ᵢ_{ₘ}(t) can be obtained. The embedding vector of all the features can be expressed as:

x₀=Concat(aᵤ_{ₙ}(t),aᵢ_{ₘ}(t),cᵤ_{ₙ}ᵢ_{ₘ}(t))∈ [symbol] ^{d}^{_{U}}^{+d}^{_{I}}^{+d}^{_{C}} (7)

where Concat( ) is the concatenation operation. Instead of using the embedding vector x₀(t) directly, it is passed through a feature crossing network to learn high-order interaction across features and a fusion layer to reduce the dimensionality.

With reference to FIG. 5, the contextual information extraction module 304 also includes a feature crossing network. The feature crossing network consists of L feature crossing layers. The output xₗ₊₁∈ [symbol] ^{d}^{_{U}}^{+d}^{_{I}}^{+d}^{_{C}} of layer l+1 is obtained by:

xₗ₊₁=x₀xₗ^{T}wₗ+bₗ+xₗ, (8)

where xₗ∈ [symbol] ^{d}^{_{U}}^{+d}^{_{I}}^{+d}^{_{C}} is the output of layer l, wₗ, bₗ∈ [symbol] ^{d}^{_{U}}^{+d}^{_{I}}^{+d}^{_{C}} are weight and bias parameters. The feature crossing is achieved by the product x₀xₗ^{T}r. Generally, a deeper feature crossing network captures higher-order interaction across features.

With reference to FIG. 5, the contextual information extraction module 304 also includes a fusion layer (attention layer). Given the embedding vector x₀ and the high-order cross feature embedding x_{L}, the fusion layer uses the self-attention mechanism to obtain the final embedding of the contextual information. As opposed to simply concatenating or adding x₀ and x_{L}, the self-attention mechanism assigns different weights to features and hence can focus on more important features. The self-attention mechanism can be mathematically expressed as:

$${e}_{c} = {\sum }_{i ∈ \{ 0 , L \}} \frac{exp ( tanh ( {w}_{i}^{⊤} \cdot {x}_{i} + {b}_{i} ) )}{{\sum }_{{i}^{′} ∈ \{ 0 , L \}} exp ( tanh ( {w}_{{i}^{′}}^{⊤} \cdot {x}_{{i}^{′}} + {b}_{{i}^{′}} ) )} {x}_{i} , \qquad ( 9 )$$

where wᵢ and bᵢ are the weights and the bias of the attention layer, and e_{c} is the final output for contextual information extraction module.

### User Interest Modelling Module 306

The inventors of the present invention have devised, through research, experiments, and/or trials, that user interests are generally diverse and dynamic, and may have a considerable impact on the recommendation performance. Therefore, in one embodiment, the user-item interactions are used to learn the user interests.

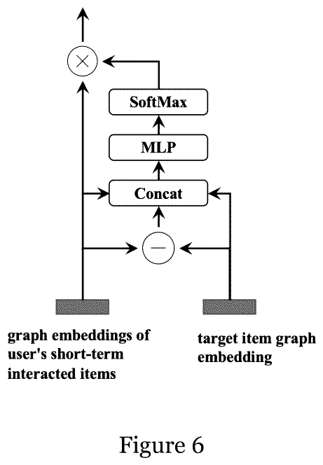

FIG. 6 illustrates operation of the user interest modelling module 306 in one embodiment. In this embodiment, the graph embedding of the target item and user's recent interacted item are concatenated, fed into an MLP, and then the softmax function is used to get the attention weight. The attention weight is multiplied with the user's recent interacted item embeddings and the weighted sum is used to represent user interests.

In this embodiment, to learn user uₙ's interest in a target item iₘ, K items that this user interacted with are randomly selected. Denote this set of K items as [symbol] ᵤ_{ₙ}={iᵤ_{ₙ}₁, iᵤ_{ₙ}₂, . . . iᵤ_{ₙ}_{K}}, where K is a hyperparameter. The obtained (obtained from module 302) embedding eᵢ_{ₘ} of the target item iₘ and embeddings

$${e}_{{i}_{{u}_{n} , k}}$$

of the selected items iᵤ_{ₙ}ₖ for k=1, . . . , K can be used. User uₙ's “valuation” (relative to the target item iₘ) of the k selected item iᵤ_{ₙ}_{,k} can be learned through a MLP:

$${v}_{k} = MLP ( {e}_{{i}_{{u}_{n} , k}} , {e}_{{i}_{m}} , {e}_{{i}_{{u}_{n} , k}} - {e}_{{i}_{m}} ) ∈ ℝ . \qquad ( 10 )$$

Then user uₙ's interest in the target item iₘ can be calculated by passing the embeddings of the selected items through a self-attention layer:

$${θ}_{{u}_{n} {i}_{m}} = {\sum }_{k = 1}^{K} \frac{exp ( {u}_{k} )}{{\sum }_{j = 1}^{K} exp ( {u}_{j} )} \cdot {e}_{{i}_{{u}_{n} , k}} . \qquad ( 11 )$$

### 4.4 Multi-Interactive Learning Module 308A-D

Through the operation of the graph embedding module 302, the contextual information extraction module 304, and the user interest modelling module 306, a set of latent vectors for the users and items in interaction-based feature learning, denoted as Vᵤ, Vₗ, V_{c}, representing user interest vector, contextual vector, and collaborative vector respectively can be obtained.

The inventors of the invention have realized the importance of learning high-order interactive information from different feature representations. The intuition is that different representations describe different aspects of the users and items. The inventors of the invention appreciate that directly concatenating them is not enough for well representation learning and so have proposed a multi interactive learning module formed by various local interactive attention modules 308A-C and a global interactive attention module 308D. The importance of each component can be learned by an attention mechanism. Besides, the representation interaction can be learned by a feature crossing structure.

With respect to local interaction learning, the contextual representation of the user and item is considered as their inherent attributes, thus the latent contextual vector learned above describes the characteristics of users and items. The collaborative feature provides rich information about the user's general preferences. The user interest models the personalized preference with respect to the specific items. Hence, each latent vector expresses the user/item in a different way and a single latent vector does not represent the users and items to their fullness. Therefore, in one embodiment, there is applied a learning process for latent representation of the interaction between interest features, collaborative features, and contextual features. In one embodiment, the interaction between every two of the components are learned. Similar to the user interest part (user interest modelling), an attention mechanism is applied to quantify the importance of representation interaction and to calculate the scaled attention representation, as follows.

Let V represent a set of feature vectors from collaborative vector, contextual vector, and interest vector respectively. Vₜ is a subset of V. The R_{cl} represents the feature interaction between the candidate user interest and contextual information. First, the contextual information is concatenated with the candidate user interest representation to get the interactive feature representation, formulated by:

Vᵤₜ^{k}=Concat(Vᵤ^{k},Vₜ). (12)

Then the attention mechanism is adopted to emphasize different parts of user interest by assigning different weights. The formula for the final representation Rᵤₜ is

$${R}_{ut} = {\sum }_{k = 1}^{K} \frac{exp ( tanh ( {V}_{ut}^{k} \cdot {W}_{ut}^{k} + {b}_{ut}^{k} ) )}{{\sum }_{{k}^{′} = 1}^{K} exp ( tanh ( {V}_{ut}^{{k}^{′}} \cdot {W}_{ut}^{{k}^{′}} + {b}_{ut}^{{k}^{′}} ) )} {V}_{ut}^{k} . \qquad ( 13 )$$

Moreover, let R_{uc} represents the feature interaction between the candidate user interest and collaborative information. Similarly, the final representation formula for R_{uc} can be obtained:

$${V}_{u c}^{k} = C o n c a t ( {V}_{u}^{k} , {V}_{c} ) \qquad ( 14 )$$

$${R}_{u c}^{k} = {\sum }_{k = 1}^{K} \frac{exp ( tanh ( {V}_{uc}^{k} \cdot {W}_{u c}^{k} + {b}_{u c}^{k} )}{{\sum }_{{k}^{′} = 1}^{K} exp ( tanh ( {V}_{uc}^{{k}^{′}} \cdot {W}_{u c}^{{k}^{′}} + {b}_{u c}^{{k}^{′}} ) )} {V}_{u c}^{k} .$$

With respect to global interaction learning, in one embodiment, attention mechanism is also adopted. Specifically, all the embedding are concatenated, denoted as Rₐᵢ=[R₁, R₂, . . . Rₙ] where Rₐᵢ in {R₁, R₂, . . . Rₙ} is a kind of embedding extracted in the previous module. Then the attention mechanism is used to process and the formula is denoted as:

$${R}_{a o} = {\sum }_{i = 1}^{n} \frac{exp ( tanh ( {R}_{i} \cdot {W}_{i} + {b}_{i} ) )}{{\sum }_{{i}^{′} = 1}^{n} exp ( tanh ( {R}_{{i}^{′}} \cdot {W}_{{i}^{′}} + {b}_{{i}^{′}} ) )} {R}_{i} , \qquad ( 15 )$$

where Rₐₒ is the final output for global interaction learning module.

### Multilayer Perceptron Module 310

The inventors of the invention have realized that a tower-shaped MLP structure can be used for predicting ratings in recommender system, as disclosed in Wengi Fan, Yao Ma, Qing Li, Yuan He, Eric Zhao, Jiliang Tang, and Dawei Yin. 2019. Graph Neural Networks for Social Recommendation. arXiv preprint arXiv:1902.07243 (2019) and Xiangnan He, Lizi Liao, Hanwang Zhang, Ligiang Nie, Xia Hu, and Tat-Seng Chua. 2017. Neural collaborative filtering. In Proceedings of the 26th international conference on world wide web.173-182.

In one embodiment of the framework, a DNN prediction model, in particular a MLP 310 (e.g., tower-shaped MLP), is used as the prediction network. The input of the MLP 310 includes the global feature representation generated by the global interaction module. To make accurate predictions, 4 un-interacted items for a user are also used to generate negative samples. In one embodiment the MLP 310 has fully connected layers, uses softmax function as the activation function of the output layer, and uses rectified linear unit (ReLU) as the activation function of the other layers. The MLP 310 can be trained using a mini-batch gradient descent and Adaptive Moment Estimation (Adam) optimization algorithm.

Experiments (e.g., simulations) are performed to test the performance of the system 300. The experiments are performed on real-world datasets from different domains for performance evaluation. Various components of the system 300 are also analysed.

The datasets used in the experiments are as follows. In this example, 4 real-world datasets are used to test the effectiveness of the proposed HySAGE framework or system 300. The datasets are described as follows and their statistical characteristics are shown in Table 1. Among them, Kaggle-Movie and MovieLens—100K are movie datasets. Yelp and Amazon-Kindle are review datasets:
Yelp: this dataset is from Yelp-2018 challenge which is to recommend business webpages to users. To ensure the quality of dataset, the dataset is sampled to get a sub-dataset, to make sure that every user gives at least 5 ratings and every business at least receives 5 ratings from users.
Amazon-Kindle: this dataset is from the Amazon review data to recommend e-books to users. Specifically, a 10-core setting is applied to ensure the quality of dataset. Finally a dataset contains 14355 users and 15884 items, in total 367478 records. It has similar user number and item number to the Yelp dataset, however, the interactions are sparser than the Yelp dataset. The dataset is used to test if the proposed method still works when user-item interactions are sparse.
MovieLens-100K: This is a canonical movie recommendation dataset. It is a stable movie rating dataset collected by GroupLens. This dataset can be used for evaluating recommendation algorithms.
Kaggle-Movie: This is an extended MovieLens dataset released on Kaggle for movie recommendation. The movie rating dataset is released on Kaggle. This dataset is an extended edition of movielens dataset. Movies which have less than 2 records have been removed from the dataset.

TABLE 1
Dataset description

| Dataset | No. of user | No. of item | No. of rating | Sparsity |
|---|---|---|---|---|
| Yelp-2018 | 21284 | 16771 | 984,000 | 99.72% |
| Amazion- | 14355 | 15884 | 367478 | 99.84% |
| Kindle | | | | |
| MovieLens- | 943 | 1682 | 100,000 | 94.12% |
| 100K | | | | |
| Kaggle-Movie | 670 | 5977 | 96,761 | 98.55% |

The baselines used in the experiments are as follows. Specifically the proposed HySAGE algorithm is compared with the following algorithms. Their performance over 5 runs on the testing set are reported.
Item popularity: This baseline ranks items by its popularity and utilize no collaborative information.
Bayesian Personalized Ranking (BPR) (as disclosed in Steffen Rendle, Christoph Freudenthaler, Zeno Gantner, and Lars Schmidt-Thieme. 2009. BPR: Bayesian personalized ranking from implicit feedback. In Proceedings of the 25th Conference on Uncertainty in Artificial Intelligence. 452-461): Instead of optimizing over point-wise user-item rating, this model is trained to rank interacted item higher than those un-interacted.
MF (as disclosed in Yehuda Koren, Robert Bell, and Chris Volinsky. 2009. Matrix factorization techniques for recommender systems. Computer 42, 8 (2009), 30-37.)+NS: A traditional matrix factorization method with negative sampling (NS) to enhance the data.
Neural Collaborative Filtering (NCF) (as disclosed in Xiangnan He, Lizi Liao, Hanwang Zhang, Liqiang Nie, Xia Hu, and Tat-Seng Chua. 2017. Neural collaborative filtering. In Proceedings of the 26th international conference on world wide web. 173-182): A deep learning based collaborative filtering method using a deep tower-shaped MLP.
JRL (as disclosed in [36]): A multi-layer neural network incorporating elementwise products of the user and item embedding.
NeuMF (as disclosed in Xiangnan He, Lizi Liao, Hanwang Zhang, Liqiang Nie, Xia Hu, and Tat-Seng Chua. 2017. Neural collaborative filtering. In Proceedings of the 26th international conference on world wide web. 173-182): A deep learning based collaborative filtering model by combining generalized matrix factorization and NCF.
GEM-RS (as disclosed in Weijing Chen, Weigang Chen, and Linqi Song. 2020. Enhancing Deep Multimedia Recommendations Using Graph Embedding s. In 2020 IEEE Conference on Multimedia Information Processing and Retrieval (MIPR). IEEE, 161-166): GEM-RS uses graph embedding to learn collaborative information.
PinSage (as disclosed in Rex Ying, Ruining He, Kaifeng Chen, Pong Eksombatchai, William L Hamilton, and Jure Leskovec. 2018. Graph convolutional neural networks for web-scale recommender systems. In Proceedings of the 24th ACM SIGKDD International Conference on Knowledge Discovery & Data Mining. 974-983): A large scale graph convolutional network that aggregates random walks and graph convolutions operations.
Neural Graph Collaborative Filtering (NGCF) (as disclosed in Xiang Wang, Xiangnan He, Meng Wang, Fuli Feng, and Tat-Seng Chua. 2019. Neural graph collaborative filtering. In Proceedings of the 42nd international ACM SIGIR conference on Research and development in Information Retrieval) A neural graph collaborative filter method that mines collaborative signal from graph structure.

In terms of experiment settings, for all deep-learning-based methods, a rectified linear unit (ReLU) is used as the activation function. Learning rates are set as 0.01. L2 regulations are 0.0000001, batch sizes are 256. For all datasets (Yelp & Amazon & ML100K & Kaggle) the embedding size is 64 for a fair comparison. In NCF, NeuMF, and GEM-RS, node number halved by layer and the last layer has 8 nodes. In JRL, in total it has three layers and every layer has the same node number. In the embedding of HySAGE, walk length is 20 and walk number is 100.

In the experiment a leave-one-out evaluation strategy is used: reserve the latest interacted item for every user as the test item. Then, a list of items is generated and the items are ranked using predicted score. In the setting, t items are recommended to a user each time and the following two metrics are used to evaluate the performance of different algorithms: Hit Ratio (HR) measuring the chance that our recommendation list contains users' interested items and a weighted version of HR, termed Normalized Discounted Cumulative Gain (NDCG), which puts more weight on items that are ranked higher in the recommendation list.

Table 2 shows the overall performance of all the methods. As seen from Table 2, the deep learning based algorithms (JRL, NCF, NeuMF, GEM-RS) in general, perform better than traditional methods (Item popularity, MF+NS, BPR). Besides, the Item-popularity method performs much worse than other methods among all datasets. This is reasonable since the Item-popularity method do not mine the collaborative information between user and item. Also, neural based methods and graph based methods shows better performance over other methods. This is because these kinds of method could learn the non-linear representation better with graph structure and neural network. For example, the NCF use neural network to learn the collaborative information. This proves that it is promising to introduce neural networks and graph structure into the system, since these structures could enhance representation learning and interaction modelling in recommendation. Also, the proposed HySAGE approach consistently achieves best score over all four datasets. It can be seen that the improvements gained by HySAGE are consistent and stable. On average, the relative improvement of HySAGE against the best baseline is 24.74% for HR@10 and 71.48% for NDCG@10. For the sparsest dataset, Yelp, it gains a 20.81% relative improvement compared to the best baseline. Even for the sparse dataset without user feature data, Kindle, it still gains a 24.77% relative improvement over the best baseline. This result implies that HySAGE is effective for recommendation tasks on datasets with different characteristics. Moreover, the significant performance gap between HySAGE and GEMRS validates that the potential user interest mining and context-aware user-item representation learning devised for HySAGE captures more knowledge about users' diverse rating behaviours on items by considering both the individual characteristics of the user and item and their interactions.

TABLE 2
Performance Comparison

| | Yelp | | Amazon-Kindle | | MovieLens-100K | | Kaggle-Movie | |
|---|---|---|---|---|---|---|---|---|
| | HR@10 | NDCG@10 | HR@10 | NDCG@10 | HR@10 | NDCG@10 | HR@10 | NDCG@10 |
| Item- | 0.2940 | 0.1611 | 0.2755 | 0.1466 | 0.4189 | 0.2337 | 0.4829 | 0.2713 |
| popularity | | | | | | | | |
| MF + NS | 0.6712 | 0.4011 | 0.5925 | 0.3691 | 0.6351 | 0.3549 | 0.5956 | 0.3691 |
| BPR | 0.7239 | 0.4212 | 0.6925 | 0.4176 | 0.5762 | 0.3021 | 0.5887 | 0.3753 |
| JRL | 0.6889 | 0.4217 | 0.6834 | 0.4331 | 0.6473 | 0.3657 | 0.6349 | 0.3881 |
| NCF | 0.7245 | 0.4316 | 0.7134 | 0.4372 | 0.6525 | 0.3789 | 0.6617 | 0.3973 |
| NeuMF | 0.7688 | 0.4734 | 0.7194 | 0.4469 | 0.6522 | 0.3918 | 0.6647 | 0.4036 |
| GEM-RS | 0.7886 | 0.4920 | 0.7637 | 0.4911 | 0.6681 | 0.3950 | 0.6885 | 0.4280 |
| PinSage | 0.7625 | 0.4371 | 0.7184 | 0.4424 | 0.6660 | 0.4010 | 0.6706 | 0.3986 |
| NGCF | 0.7833 | 0.4616 | 0.7207 | 0.4544 | 0.6706 | 0.4229 | 0.6734 | 0.4031 |
| HySAGE | 0.9527 | 0.8571 | 0.9529 | 0.8095 | 0.8348 | 0.6832 | 0.8841 | 0.7443 |
| Improvement | 20.81% | 74.21% | 24.77% | 64.83% | 24.95% | 72.96% | 28.41% | 73.90% |

To demonstrate the effectiveness of some of the modules in our proposed framework, a set of ablation experiments are designed. Specifically, the experiment is repeated by removing one module from the proposed HySAGE model and testing the performance of these incomplete models on four datasets. The designed incomplete models are described as follow,
HySAGE-Variation 1 (w/o multimodal information): The proposed HySAGE without the feature extraction of multimodal information in contextual information extraction module 304.
HySAGE-Variation 2 (w/o side information): The proposed HySAGE without the feature extraction of side information in contextual information extraction module 304.
HySAGE-Variation 3 (w/o user interest): The proposed HySAGE without the user potential interest mining module 306.

Tables 3A and 3B show the ablation experiments results. From the Tables, it can be observed that HySAGE achieves the best results on all datasets, which verifies the importance of the modules. Among them, the experimental results of HySAGE without user interest mining drop sharply, which proves that the lack of attentively learning the user interest could significantly decrease the learning ability of the framework. Without the side information extraction or multimodal information extraction, the performance of the framework still decreases. This reflects that the contextual information contains abundant auxiliary information, which improves the model performance. However, compared with the other modules, the impact of contextual information is relatively small. The contextual information module is like a residual network to supplement the extra content information to the HySAGE framework. Throughout these three ablation experiments, it turns out that each module improves the model performance from different aspects and is meaningful in different respects.

TABLE 3A
Ablation study of recommendation performance in one of the two datasets (Kaggle)

| | Kaggle | | | | | |
|---|---|---|---|---|---|---|
| | HR@5 | NDCG@5 | HR@10 | NDCG@10 | HR@20 | NDCG@20 |
| HySAGE | 0.8349 | 0.7471 | 0.9038 | 0.7694 | 0.9519 | 0.7817 |
| HySAGE- | 0.7754 | 0.7517 | 0.8991 | 0.7697 | 0.9488 | 0.7826 |
| Variation1 | | | | | | |
| HySAGE- | 0.8096 | 0.7210 | 0.8841 | 0.7443 | 0.9411 | 0.7584 |
| Variation2 | | | | | | |
| HySAGE- | 0.5406 | 0.3831 | 0.6792 | 0.4256 | 0.8133 | 0.4590 |
| Variation3 | | | | | | |

TABLE 3B
Ablation study of recommendation performance in one of the two datasets (Movielens)

| | Movielens | | | | | |
|---|---|---|---|---|---|---|
| | HR@5 | NDCG@5 | HR@10 | NDCG@10 | HR@20 | NDCG@20 |
| HySAGE | 0.8147 | 0.7348 | 0.8838 | 0.7572 | 0.9417 | 0.7718 |
| HySAGE- | 0.7335 | 0.6301 | 0.8332 | 0.6619 | 0.9103 | 0.7086 |
| Variation1 | | | | | | |
| HySAGE- | 0.7489 | 0.6553 | 0.8348 | 0.6832 | 0.9104 | 0.7023 |
| Variation2 | | | | | | |
| HySAGE- | 0.5047 | 0.3549 | 0.6702 | 0.4076 | 0.8213 | 0.4445 |
| Variation3 | | | | | | |

The impact of different model settings for proposed HySAGE is further investigated with experiments.

The first setting of interest is the impact of the Hyperparameter K. Recall that a hyperparameter K is selected in the user interest mining module to randomly sample K items and derive user potential interest using the attention mechanism. The impact of the hyperparameter K is studied, and it is worthwhile to note that parameter selection determines the model capacity. For a fair comparison, other settings are kept the same and the selection of K is varied.

Table 4 shows the model performance of HySAGE. It can be seen that the performance of the HySAGE could continually be improved with the increase of K. In essence, higher K means more user interest information would be learned. Then HySAGE can reap the benefits from better representation learning of user interest. Therefore, the increase of K leads to better model performance.

TABLE 4
HySAGE performance with different hyperparameter values K

| Hyper Parameter | | K = 1 | K = 3 | K = 5 | K = 7 |
|---|---|---|---|---|---|
| Movielens | HR@5 | 0.5093 | 0.5726 | 0.8147 | 0.8837 |
| | NDCG@5 | 0.3618 | 0.4476 | 0.7348 | 0.8344 |
| | HR@10 | 0.6760 | 0.7144 | 0.8838 | 0.9268 |
| | NDCG@10 | 0.4130 | 0.4932 | 0.7572 | 0.8482 |
| | HR@20 | 0.8269 | 0.8491 | 0.9417 | 0.9622 |
| | NDCG@20 | 0.4510 | 0.5273 | 0.7718 | 0.8572 |
| Kaggle | HR@5 | 0.5440 | 0.6804 | 0.8349 | 0.9065 |
| | NDCG@5 | 0.3813 | 0.5412 | 0.7471 | 0.8503 |
| | HR@10 | 0.6874 | 0.7910 | 0.9038 | 0.9437 |
| | NDCG@10 | 0.4256 | 0.5764 | 0.7694 | 0.8622 |
| | HR@20 | 0.8092 | 0.8875 | 0.9519 | 0.9721 |
| | NDCG@20 | 0.4573 | 0.5981 | 0.7817 | 0.8694 |

The second setting of interest is the impact of the embedding size. One of the experiments studies how embedding size (dimension of the embedding features, or latent features) affects the performance of the designed algorithm.

Table 5 shows the results, i.e., the performance of using different embedding sizes (32, 64, 96, 128). It can be seen that for these two datasets, embedding size of 32 almost achieves the best performance. Also, it can be seen that as the embedding size increases, the performance degrades. This is due to the fact that while the framework can extract larger dimensional features that contain more information, more computation complexity is needed. When the embedding size is too large, the convergence of the training model may not be so good due to too many parameters. Also, larger embedding size may have bring some redundancy information and inferior the result. A larger embedding size can offer capacity for capturing complex relations in the user/item preference graphs. However, larger embedding size will not bring a better performance. In practice, a larger dimension of embedding may lead to overfitting problem and increase the complexity of models, making the model hard to converges or lead to worse performance.

TABLE 5
HySAGE performance with different embedding size

| Embedding Size | | 32 | 64 | 96 | 128 |
|---|---|---|---|---|---|
| Movielens | HR@5 | 0.8354 | 0.8147 | 0.7635 | 0.7532 |
| | NDCG@5 | 0.7418 | 0.7348 | 0.6601 | 0.6597 |
| | HR@10 | 0.9031 | 0.8838 | 0.8643 | 0.8478 |
| | NDCG@10 | 0.7638 | 0.7572 | 0.6925 | 0.6903 |
| | HR@20 | 0.9583 | 0.9417 | 0.9279 | 0.9289 |
| | NDCG@20 | 0.7776 | 0.7718 | 0.7087 | 0.7109 |
| Kaggle | HR@5 | 0.8590 | 0.8349 | 0.7917 | 0.7767 |
| | NDCG@5 | 0.7748 | 0.7471 | 0.6958 | 0.6781 |
| | HR@10 | 0.9171 | 0.9038 | 0.8736 | 0.8589 |
| | NDCG@10 | 0.7937 | 0.7694 | 0.7204 | 0.7021 |
| | HR@20 | 0.9645 | 0.9519 | 0.9353 | 0.9270 |
| | NDCG@20 | 0.8055 | 0.7817 | 0.7350 | 0.7186 |

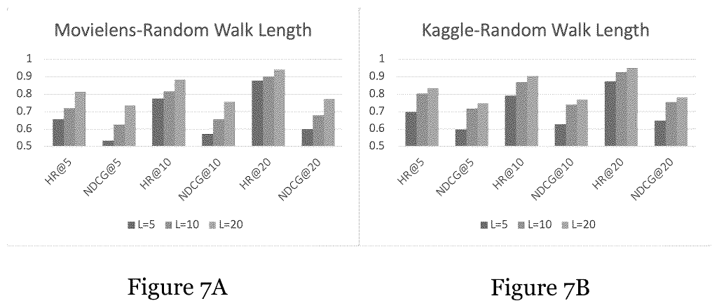

The third setting of interest is the impact of the random-walk length. One of the experiments studies how walk length affects the performance of the model. Walk length is the number of steps a walk will take. The larger the walk length is, the more possible it will for a walk to visit further nodes and discover more complex graph structures. Different walk length in the range from 5 to 20 are tested. The results are shown in FIGS. 7A and 7B. From FIGS. 7A and 7B, it can be determined that the performances of models improve continuously as the walk lengths increase. Generally walk length 20 gives the best result on the two datasets. As mentioned, users and items are connected with each other with a weighted link, though they are not directly linked. The larger the walk length is, the more likely similar users and items can appear in the same walk sequence. Walks more will preserve homophily of users and items, thus can ultimately produce more expressive and representative embeddings. In this experiment, the walk length 20 is the best choice of hyper-parameter to ensure the stability and high performance of the model. Of course, a different walk length can be used or selected in other embodiments. Also, an increasing number of walk length is beneficial. A trend can be observed that overall performance increase when the walk length is larger.

The above embodiments in relation to HySAGE has provided a context and interest enhanced graph embedding technique to boost the performance of multimedia recommendations. A bipartite graph is built from user-item interactions and random walk-based graph embedding techniques are used to extract user and item embeddings. The graph embedding is incorporated with attention mechanism to mine the user potential interest, then joint with contextual embeddings that are extracted from multimedia and side information to make multimedia recommendations. Experiments on real datasets demonstrate the effectiveness of the proposed framework and show significant benefits over existing algorithms. The embodiments of the invention provides improve techniques in the art of information filtering technologies, or more specifically, recommender systems and methods, which are inextricably linked to a computer or computer-based environment.

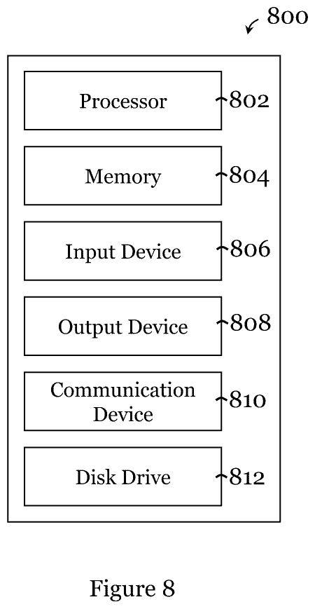

FIG. 8 shows an information handling system 800 in one embodiment. The information handling system 800 can be configured to operate as at least part of a recommender system in some embodiments (such as but not limited to the above described recommender system). The information handling system 800 can be configured to operate at least some of the recommender system operations in some embodiments (such as but not limited to the above described recommender system operations in methods 100, 200). The various modules 302, 304, 306, 308A-D, 310 in the recommender system 300 can be implemented at least partly using the information handling system 800. The information handling system 800 may be used to receive, collect, and/or store user and item related information and data to facilitate operation of the invention.

The information handling system 800 generally comprises suitable components necessary to receive, store, and execute appropriate computer instructions, commands, or codes. The main components of the information handling system 800 are a processor 802 and a memory (storage) 804. The processor 802 may include one or more: CPU(s), MCU(s), logic circuit(s), Raspberry Pi chip(s), digital signal processor(s) (DSP), application-specific integrated circuit(s) (ASIC), field-programmable gate array(s) (FPGA), and/or any other digital or analog circuitry/circuitries configured to interpret and/or to execute program instructions and/or to process signals and/or information and/or data. The memory 804 may include one or more volatile memory (such as RAM, DRAM, SRAM), one or more non-volatile memory (such as ROM, PROM, EPROM, EEPROM, FRAM, MRAM, FLASH, SSD, NAND, NVDIMM), or any of their combinations. Appropriate computer instructions, commands, codes, information and/or data may be stored in the memory 804. For example, computer instruction for operating the recommender system, the methods 100, 200, the system 300, etc., may be stored in the memory 804. User-related information and/or data (graph, etc.) and item-related information and/or data (graph, etc.) may be stored in the memory 804.

Optionally, the information handling system 800 further includes one or more input devices 806. Examples of such input device 806 include: keyboard, mouse, stylus, image scanner, microphone, tactile/touch input device (e.g., touch sensitive screen), image/video input device (e.g., camera), etc. Optionally, the information handling system 800 further includes one or more output devices 808. Examples of such output device 808 include: display (e.g., monitor, screen, projector, etc.), speaker, disk drive, headphone, earphone, printer, additive manufacturing machine (e.g., 3D printer), etc. The display may include a LCD display, a LED/OLED display, or any other suitable display, which may or may not be touch sensitive. The output device 808 may provide the determined recommendation to the user(s). The information handling system 800 may further include one or more disk drives 812 which may include one or more: solid state drive, hard disk drive, optical drive, flash drive, magnetic tape drive, etc. A suitable operating system may be installed in the information handling system 800, e.g., on the disk drive 812 or in the memory 804. The memory 804 and the disk drive 812 may be operated by the processor 802. Optionally, the information handling system 800 also includes a communication device 810 for establishing one or more communication links (not shown) with one or more other computing devices such as servers, personal computers, terminals, tablets, phones, watches, IoT devices, or other wireless or handheld computing devices. The communication device 810 may include one or more of: a modem, a Network Interface Card (NIC), an integrated network interface, a NFC transceiver, a ZigBee transceiver, a Wi-Fi transceiver, a Bluetooth® transceiver, a radio frequency transceiver, an optical port, an infrared port, a USB connection, or other wired or wireless communication interfaces. Transceiver may be implemented by one or more devices (integrated transmitter(s) and receiver(s), separate transmitter(s) and receiver(s), etc.). The communication link(s) may be wired or wireless for communicating commands, instructions, information and/or data. In one example, the processor 802, the memory 804, and optionally the input device(s) 806, the output device(s) 808, the communication device(s) 810 and the disk drive(s) 812 are connected with each other through a bus, a Peripheral Component Interconnect (PCI) such as PCI Express, a Universal Serial Bus (USB), an optical bus, or other like bus structure. In one embodiment, at least some of these components may be connected through a network such as the Internet or a cloud computing network. A person skilled in the art would appreciate that the information handling system 800 shown in FIG. 8 is merely exemplary and that the information handling system 800 can in other embodiments have different configurations (e.g., include additional components, has fewer components, etc.). In some embodiments, the information handling system 800 takes the form of a mobile or edge computing devices, such as mobile phone (smart phone), tablet, laptop, desktop computer, IoT devices, etc. The information handling system 800 can be implemented on a single device or apparatus, or implemented distributively across multiple devices or apparatuses.

Although not required, the embodiments described with reference to the Figures can be implemented as an application programming interface (API) or as a series of libraries for use by a developer or can be included within another software application, such as a terminal or computer operating system or a portable computing device operating system. Generally, as program modules include routines, programs, objects, components and data files assisting in the performance of particular functions, the skilled person will understand that the functionality of the software application may be distributed across a number of routines, objects and/or components to achieve the same functionality desired herein.

It will also be appreciated that where the methods and systems of the invention are either wholly implemented by computing system or partly implemented by computing systems then any appropriate computing system architecture may be utilized. This will include stand-alone computers, network computers, dedicated or non-dedicated hardware devices. Where the terms “computing system” and “computing device” are used, these terms are intended to include (but not limited to) any appropriate arrangement of computer or information processing hardware capable of implementing the function described.

It will be appreciated by persons skilled in the art that numerous variations and/or modifications may be made to the invention as shown in the specific embodiments to provide other embodiments of the invention. The described embodiments of the invention should therefore be considered in all respects as illustrative, not restrictive. The method steps illustrated need not be performed in the order specified, as long as order of the steps is feasible. Depending on applications, some method steps might be performed substantially simultaneously, some method steps might be performed sequentially, etc. Non-exhaustive optional features of the invention are set forth in the summary of the invention section. Some embodiments of the invention may include one or more of these optional features. The recommender system can be used for providing recommendations of different types of items, including but not limited to media or multimedia items. The skilled person appreciates that the machine learning models, methods, etc., and their specific implementations (hyperparameters, biases, etc.), can be different from those illustrated.

1. A computer-implemented method for operating a recommender system, comprising:
(a) processing user-item interaction data associated with interactions between users and items;
(b) processing contextual data associated with the users and/or the items; and
(c) determining, based on the processing of the user-item interaction data and the contextual data, a recommendation of at least one of the items for at least one of the users;
wherein the user-item interaction data changes less frequently over time than the contextual data; and
wherein the at least one of the users have not interacted with the at least one of the items in the recommendation.

2. The computer-implemented method of claim 1, wherein step (a) comprises:
(a1) processing interaction information between users and items to determine collaborative vector representations of the users and the items.

3. The computer-implemented method of claim 2, wherein step (b) comprises:
(b1) processing contextual information of the users and the items to determine contextual vector representations associated with attributes of the users, attributes of the items, interactions between the users and the items.

4. The computer-implemented method of claim 3, wherein step (c) comprises:
(c1) processing collaborative vector representations of one or more of the items that one of the users has interacted with, to determine user interest vector representation of an interest of the user on one of the items which the user has not interacted with;
(c2) determining vector representations associated with interactions between at least two of the contextual vector representations, the collaborative vector representations, and the user interest vector representation; and
(c3) processing the vector representation associated with interactions using a multilayer perceptron to determine a recommendation of at least one item for the user.

5. The computer-implemented method of claim 4, wherein step (c2) comprises:
(c2a) determining vector representations associated with local interactions between at least two of the contextual vector representations, the collaborative vector representations, and the user interest vector representation; and
(c2b) determining vector representation associated with global interactions based on the vector representations associated with local interactions, the contextual vector representations, the collaborative vector representations, and the user interest vector representation.

6. The computer-implemented method of claim 2, wherein in step (a1) the interaction information between users and items comprises a user-item interaction bipartite graph.

7. The computer-implemented method of claim 6, wherein step (a1) comprises:
processing the user-item interaction bipartite graph to determine information associated with similarities of the users and information associated with similarities of the items.

8. The computer-implemented method of claim 7,
wherein the information associated with similarities of the users comprises a user similarity graph associated with the users, and the user similarity graph includes multiple nodes each associated with a respective one of the users; and
wherein the information associated with similarities of the items comprises an item similarity graph associated with the items, and the item similarity graph includes multiple nodes each associated with a respective one of the items.

9. The computer-implemented method of claim 8, wherein step (a1) further comprises:
processing the item similarity graph using a graph embedding method to obtain item nodes sequence; and
processing the user similarity graph using a graph embedding method to obtain user nodes sequence.

10. The computer-implemented method of claim 9, wherein the graph embedding method comprises random-walk based graph embedding method.

11. The computer-implemented method of claim 9, wherein step (a1) further comprises:
processing the item nodes sequence using a co-occurrence based method to determine the collaborative vector representations of items; and
processing the user nodes sequence using a co-occurrence based method to determine the collaborative vector representations of users.

12. The computer-implemented method of claim 3, wherein in step (b1) the contextual information comprises at least some of:
categorical features associated with the users;
categorical features associated with the items;
dense features associated with the users;
dense features associated with the items;
text data associated with inputs of the users;
text data associated with the items;
image data associated with the items; and
image data associated with the users.

13. The computer-implemented method of claim 12, wherein step (b1) comprises:
processing categorical features associated with the users and/or categorical features associated with the items by performing a one-hot embedding operation.

14. The computer-implemented method of claim 12, wherein step (b1) comprises:
processing dense features associated with the users and/or dense features associated with the items by performing a normalization operation.

15. The computer-implemented method of claim 12, wherein step (b1) comprises:
processing text data associated with inputs of the users and/or text data associated with the items using a transformer-based machine learning model.

16. The computer-implemented method of claim 15, wherein the transformer-based machine learning model comprises a BERT-based model.

17. The computer-implemented method of claim 12, wherein step (b1) comprises:
processing image data associated with the items and/or image data associated with the users using a convolutional neural network.

18. The computer-implemented method of claim 17, wherein the convolutional neural network comprises ResNet.

19. The computer-implemented method of claim 12, wherein step (b1) comprises:
processing categorical features associated with the users and/or categorical features associated with the items by performing a one-hot embedding operation;
processing dense features associated with the users and/or dense features associated with the items by performing a normalization operation;
processing text data associated with inputs of the users and/or text data associated with the items using a transformer-based machine learning model;
processing image data associated with the items and/or image data associated with the users using a convolutional neural network; and
processing the processed categorical features, the processed dense features, the processed text data, and the processed image data using a feature crossing network and a self attention mechanism to obtain the contextual vector representations.

20. The computer-implemented method of claim 4, wherein step (c1) comprises:
selecting at least some of the items that the user has interacted with;
processing, based on a concatenation operation, the one or more collaborative vector representations associated with the at least some items that the user has interacted with and the collaborative vector representation associated with the item which the user has not interacted with;
processing data obtained after the concatenation operation using a multilayer perceptron and a softmax function to obtain attention weights; and
applying the attention weights to the collaborative vector representations associated with the one or more items that the user has interacted with to obtain the user interest vector representation.

21. The computer-implemented method of claim 20, wherein the selecting includes selecting one or more most recent items that the user has interacted with.

22. The computer-implemented method of claim 20, wherein the applying includes multiplying the attention weights with the collaborative vector representations associated with the one or more items that the user has interacted with to obtain the user interest vector representation.

23. The computer-implemented method of claim 5, wherein step (c2a) comprises:
determining first feature vector representations associated with interactions between the contextual vector representations and the user interest vector representation; and/or
determining second feature vector representations associated with interactions between the collaborative vector representations and the user interest vector representation.

24. The computer-implemented method of claim 1, further comprising:
outputting the recommendation to the user.

25. The computer-implemented method of claim 24, wherein the outputting comprises:
providing a list containing one or more items in the recommendation to the user.

26. The computer-implemented method of claim 1, wherein the items comprise media or multimedia items.

27. The computer-implemented method of claim 26, wherein the media or multimedia items are for use or operation on a mobile or edge device.

28. A recommender system, comprising:
one or more processors; and
memory storing one or more programs configured to be executed by the one or more processors, the one or more programs including instructions for:
(a) processing user-item interaction data associated with interactions between users and items;
(b) processing contextual data associated with the users and/or the items; and
(c) determining, based on the processing of the user-item interaction data and the contextual data, a recommendation of at least one of the items for at least one of the users;
wherein the user-item interaction data changes less frequently over time than the contextual data; and
wherein the at least one of the users have not interacted with the at least one of the items in the recommendation.

29. A non-transitory computer-readable storage medium storing one or more programs configured to be executed by one or more processors, the one or more programs including instructions for:
(a) processing user-item interaction data associated with interactions between users and items;
(b) processing contextual data associated with the users and/or the items; and
(c) determining, based on the processing of the user-item interaction data and the contextual data, a recommendation of at least one of the items for at least one of the users;
wherein the user-item interaction data changes less frequently over time than the contextual data; and
wherein the at least one of the users have not interacted with the at least one of the items in the recommendation.
